(19) United States
(12) Patent Application Publication
(10) Pub. No.: US 2023/0110232 A1
(43) Pub. Date: Apr. 13, 2023

(54) THROUGH TRANSMISSION CONNECTING DEVICE, CONNECTING METHOD USING THE DEVICE AS WELL AS RESULTING CONNECTION STRUCTURE

(71) Applicant: Branson Ultraschall Niederlassung der Emerson Technologies GmbH & Co. OHG, Dietzenbach (DE)

(72) Inventor: Oliver Kiehl, Rödermark (DE)

(21) Appl. No.: 17/951,810

(22) Filed: Sep. 23, 2022

(30) Foreign Application Priority Data
Oct. 8, 2021 (EP) 21 201 762.8

(51) Int. Cl. B23K 26/26; H01M 8/0297

(52) U.S. Cl. CPC B23K 26/26; H01M 8/0297; H01M 8/188

(57) ABSTRACT

An inventive through transmission connecting device for connecting a first component made of a light absorbing material to a second component made of a light transmissive material by means of a light transmission bonding technology. The connecting device includes a first tool mounted to a first support retaining the first component and a second tool mounted to a second support retaining the second component. The first tool and the second tool are movable with respect to each other and the first tool is at least partly made of or includes a layer of a thermal isolator having a high thermal resistance.

### CROSS REFERENCE TO RELATED APPLICATION

This application claims priority of European Patent Application No. EP 21 201 762.8, filed on Oct. 8, 2021, which is herein incorporated by reference in its entirety.

### FIELD OF THE INVENTION

The present invention is related to a through transmission connecting device for connecting a first component made of a light absorbing material to a second component made of a light transmissive material by means of a light transmission bonding or welding technology, a connecting method using the through transmission connecting device as well as a resulting connection structure consisting of a first component made of a light absorbing material and a second component made of a light transmissive material.

### BACKGROUND OF THE INVENTION

In the field of energy storage, in particular of storing electrical energy, various solutions exist. One of these solutions is the use of batteries, which has become more and more important in the recent years.

Within the field of batteries, again several alternative solutions exist. Among others, a flow battery or redox flow battery can be used which is a type of electrochemical cell where chemical energy is provided by two chemical components dissolved in liquids that are pumped through the system on separate sides of a membrane. An example of a redox battery is described in EP 0 312 875 A1.

In such a battery system, the electrode is usually comprised of graphite due to the large electrochemical potential window. An exemplary production method for a respective graphite electrode is described in EP 2 519 479 A2. Therein, a layered composite material is produced containing at least one layer of a textile fabric and at least one graphite-containing molded body which is obtained by a method in which graphite particles are mixed with at least one solid organic additive to form a mixture and the thus obtained mixture is then compressed.

In particular in view of the prior art, it is a problem of the present invention to provide an alternative method for producing a respective graphite electrode for use in an electrochemical cell as well as a respective device for producing such a graphite electrode.

### SUMMARY OF THE INVENTION

The above object is solved by a through transmission connecting device, a connecting method using the inventive through transmission connecting device as well as a connection structure according to the claims. Further preferred embodiments and developments result from the following description, the drawings, as well as the appending claims.

An inventive through transmission connecting device for connecting a first component made of a light absorbing material to a second component made of a light transmissive material by means of a light transmission bonding technology, comprises a first tool mounted to a first support retaining the first component and a second tool mounted to a second support retaining the second component, wherein the first and the second tool are moveable with respect to each other and the first tool is at least partly made of or comprises a layer of a thermal isolator having a high thermal resistance.

The general construction of a trough transmission connecting device, for example a through transmission welding device, as well as the course of procedure is known in the prior art, in particular in the field of plastic welding. Therein, the through transmission welding devices are used for connecting a first plastic component of a light or laser absorbing material to a second plastic component of a light or laser transmissive material. The respective process is also denoted as laser plastic welding, through-transmission welding or polymer welding although the concept to connect two plastic components is the same.

The basic principle of this joining or connecting method is transmitting laser radiation through one plastic component, i.e., the transmissive component, to create a connection. Unlike standard welding where the energy is applied at the surface of the materials, transmission connecting methods apply the energy in between two plastic components at their interfaces. This can be done by irradiating the complete connecting portion, connecting structure or weld line at the same time, i.e., simultaneous light or laser transmission welding. Further methods are, beside others, the quasi simultaneous through transmission welding or the contour welding. Within the present invention, the usage of a simultaneous method is particularly preferred.

Now, the structure and functioning of the inventive trough transmission connecting device is discussed based on the exemplary production of a graphite electrode for use in an electrochemical cell or the like.

The exemplary graphite electrode consists of a first component made of a light or laser absorbing material. In a preferred example, the first component is a plastic matrix material filled with graphite particles. The second component, which provides for example a frame for a later mounting of the graphite containing first component into the redox flow battery cell stack, consists preferably of a plastic which is transparent for the light or laser used.

For connecting, i.e., bonding or welding, the first component to the second component, first the first and second component are arranged between the first and the second tool. For example, the first component is arranged in the first tool and the second component is arranged on the first component or, alternatively, in the second tool. In this regard, it is assumed that the light, in particular the laser light, for heating the first component at the connecting structure or portion comes from the second tool and, thus, passes through the second component first. For example, the first tool which is mounted to the first support is a lower tool and the first support is a lifting table. Accordingly, the second tool which is mounted to the second support is an upper tool comprising a waveguide having a transparent plate at its exit end and being mounted with the opposite entry end to an upper mounting plate as upper support. Preferably, the first and/or the second support are at least partly made of a metal, in particular steel or aluminum.

After the components have been arranged in the device, the first and the second tool are moved relative to each other into a connecting position in which the first and the second component abut each other at least partly, preferably with the respective connecting portions.

Thereafter, a weld force is applied on the first and the second component and the first and the second component are irradiated by means of a light source while the weld force and, thus, a resulting contact pressure is maintained. Preferably, the first and the second component are irradiated in the connecting portions. After the light transmission, in particular laser light transmission, through the transparent or upper second component, the incident light is absorbed by the lower first component and transformed into heat within the material. Once the laser light is converted into heat by the absorbing component, the thermal energy is transferred to the transparent component to allow for it to soften and melt. By ensuring the two components are in intimate contact the heat energy can be conducted to the transparent component.

For being able to use a through transmission connecting method in combination with the exemplary first component, i.e., the plastic matrix material filled with graphite particles, the known devices for laser transmission welding are not suitable. In particular, it was found that it is not possible with common laser transmission welding devices to sufficiently heat the components to be connected so that a reliable connection results. Even an increase in the energy amount introduced by the light source into the components could not completely overcome this deficiency.

After intensive research, it was found that using a thermal isolator as a first tool or using a layer of a thermal isolator at the first tool overcomes this drawback. Due to the usage of this thermal isolator, applying a through transmission connecting method for producing the exemplary graphite electrode as discussed above is realizable. This is because the thermal isolator at least hinders or preferably prevents thermal conduction to, for example, the first support. This will be discussed in the following.

As a last step of the method, and in particular after the light source has been switched off and a sufficient time has passed in which the components are pressed together with the weld force for allowing the softened material to harden, the first and the second tool are moved relative to each other out of the connecting position. Now, the user can remove the produced connection structure, i.e., the exemplary graphite electrode having a frame element for assembly of the redox flow battery.

Based on the above explanations, it is a first difference to the prior art and a specific technical advantage of the present invention that a light transmission bonding technology is used for producing a graphite electrode. Particularly, the usage of this technology makes the production easier and cost efficient. A further advantage is that a device by means of which the light transmission bonding technology can be applied for manufacturing such graphite electrodes was developed.

In this regard, and particularly with respect to the through transmission connecting device, it was found that the inventive through transmission connecting device can further be used for any application, preferably any electrochemical application, in which a light or laser absorbing and highly heat conductive material as first component shall be connected, i.e., bonded or welded, to a light or laser transparent second component.

As graphite has a thermal conductivity of λ=119 to 165 W/(m K), all materials having a thermal conductivity in the range of λ≥50 W/(m K), preferably λ≥75 W/(m K) and particularly preferred λ≥100 W/(m K), are considered as highly heat conductive materials. In this regard, it is pointed out that the thermal conductivity of a material is an intensive property that indicates its ability to conduct heat. Concerning the measurement method for thermal conductivity, it is referred to the laser flash analysis or laser flash method. This analysis or method is used to measure thermal diffusivity of a variety of different materials by means of an energy pulse which heats one side of a plane-parallel sample and the resulting time dependent temperature rise on the backside due to the energy input is detected.

For the sake of completeness, it is pointed out that due to the process used, i.e., the light transmission bonding technology, the thermal isolator must, besides having a low thermal conductivity, fulfill further requirements which are inherent to this technology. For example, and as mentioned above, the first or absorbing component is heated by means of laser light. The thermal isolator must thus have a respective thermal resistance. In other words, a melting point of the thermal isolator must be well above the temperature to which the absorbing component is heated during the connecting method.

Further, the weld force applied for connecting the two components to each other must be considered. Accordingly, the thermal isolator, which must withstand this weld force and the resulting contact pressure, must have a respective resistance in this regard as well.

All these factors must be considered when evaluating a suitable thermal isolator. In the following, these requirements will become clearer based on the preferred embodiments.

In a preferred embodiment of the through transmission connecting device, the thermal isolator has a thermal conductivity of λ≤2 W/(m K), preferably λ≤1 W/(m K). By this requirement, it is particularly ensured that the thermal isolator has a low thermal conductivity, provides a suitable thermal isolation and, thus, prevents heat conduction into the first tool.

It is further preferred in the inventive through transmission connecting device that the thermal isolator has a melting point of tₘₚ≥200° C., preferably of tₘₚ≥250° C. By this requirement, the above mentioned second item is addressed. In particular, the thermal isolator does not melt during the connecting of the two components.

As a result of the above, it is particularly advantageous that the thermal isolator is a thermoplastic material, in particular a polyether ether ketone (PEEK). PEEK as a particularly preferred material for the thermal isolator has on the one hand a very low thermal conductivity of about λ=0.25 W/(m K) and, on the other hand, a high melting point of about tₘₚ=335° C. Additionally, PEEK has a sufficient resistance against the applied weld force, as discussed above.

It is furthermore preferred that the thermal isolator has a thickness in the range of 1 mm≤tᵢ≤10 cm, preferably 2.5 mm≤tᵢ≤7.5 cm and more particularly preferred 5 mm≤tᵢ≤5 cm. By means of these thickness ranges, heat conduction can be prevented in a reliable manner. In this regard, the thickness of the first tool or the respective layer depends on and is interrelated with the material used. For example, a material having a low thermal conductivity, like PEEK, may be present in a smaller thickness compared to a material having a higher thermal conductivity for which a larger thickness may be required to prevent heat conduction into the first support.

According to a particularly preferred embodiment of the through transmission connecting device, the first tool comprises additionally a non-stick coating adjacent to the thermal isolator so that the non-stick coating is present at least in the contact area of the first tool with the first component. Preferably, the non-stick coating consists of polytetrafluoroethylene. Due to this coating, a sticking of the first component to the first tool can be prevented in a process reliable manner.

With respect to the requirement regarding the force resistance, as mentioned above, it is preferable that the thermal isolator of the first tool is resistant to force, in particular to compression force, such that a sufficient stability of the thermal isolator is present during use. Specifically, a damaging of the thermal isolator due to the forces applied in pressing the components to be welded against each other, such as crack formation, shall not occur.

An inventive connecting method using an inventive through transmission connecting device for connecting a first component made of a light absorbing material to a second component made of a light transmissive material, wherein the first component has a high thermal conductivity at least in a connecting portion, comprises the steps of: arranging the first component in the first tool, arranging the second component in the second tool, moving the first and the second tool relative to each other into a connecting position in which the first and the second component abut each other at least partly, preferably with the respective connecting portions, thereafter applying a weld force on the first and the second component as well as irradiating the first and the second component by means of a light source while applying the weld force, wherein the first and the second component are preferably irradiated in the connecting portions, subsequently moving the first and the second tool relative to each other out of the connecting position. By means of this method, a connection structure, like the above exemplary graphite electrode, can be produced by means of a transmission bonding technology. For avoiding repetitions, the above discussion is referred to with respect to the resulting technical effects and advantages.

According to a preferred embodiment of the connecting method, the light source is a laser light source. Further preferred, the weld force is in the range that neither the components to be welded to each other nor the thermal isolator are damaged during the connecting step. Concerning both preferred embodiments, the above discussion of the through transmission connecting device and its respectively preferred embodiments are again referred to.

Preferably, the step of arranging the second component in the second tool comprises the steps of: arranging the second component on the first component in the first tool and moving the first and the second tool relative to each other into a transfer position in which the second tool receives the second component. Thus, the second component is transferred automatically into the second tool, which eliminates the respective manual step of arranging the second component in the second tool. In this way, the method is further automatized.

In general, and with respect to the exemplary graphite electrode as a connection structure to be produced, the method is not limited to the use of graphite or plastic matrix material filled with graphite as a first component, but it is particularly preferred to use the method in combination with any material as a first component which absorbs light and has a thermal conductivity in the range of λ≥50 W/(m K), preferably λ≥75 W/(m K) and particularly preferred λ≥100 W/(m K).

Finally, an inventive connection structure consists of a first component made of a light absorbing material and a second component made of a light transmissive material, wherein the first component has at least in a connecting portion, in which it is connected to the second component, a high thermal conductivity. In this regard, the above explanations are again referred to for avoiding repetitions.

### BRIEF DESCRIPTION OF THE DRAWINGS

In the following, the present invention will be described in detail based on the following drawings. In the listed drawings, the same reference signs denote the same elements and/or components.

FIG. 1 depicts an exemplary embodiment of an inventive through transmission connecting device in an initial state;

FIG. 2 illustrates the exemplary embodiment of the inventive through transmission connecting device of FIG. 1 in a contacting position;

FIG. 3 illustrates the exemplary embodiment of the inventive through transmission connecting device of FIGS. 1 and 2 in a pressure position;

FIG. 4 illustrates the exemplary embodiment of the inventive through transmission connecting device of FIGS. 1-3 in a connecting position at the beginning of the connecting phase;

FIG. 5 illustrates the exemplary embodiment of the inventive through transmission connecting device of FIGS. 1-4 in the connecting position in the middle of the connecting phase;

FIG. 6 illustrates the exemplary embodiment of the inventive through transmission connecting device of FIGS. 1-5 in the connecting position at the end of the connecting phase;

FIG. 7 illustrates the exemplary embodiment of the inventive through transmission connecting device of FIGS. 1-6 in an unloading or removal position; and

FIG. 8 depicts a flow chart of a preferred embodiment of an inventive connecting method.

### DETAILED DESCRIPTION OF PREFERRED EMBODIMENTS

In the following, an exemplary embodiment of an inventive through transmission connecting device 1 will be described. Usually, through transmission connecting devices are used for welding two plastic components to each other, for example in the field of the automotive industry when producing a rear light or the like. The respective process is also denoted as laser plastic welding, through-transmission welding or polymer welding, although the concept to connect two plastic components is the same.

The basic principle of this joining or connecting method is transmitting laser radiation through one plastic component, i.e., the transmissive component, to create a connection. Unlike standard welding where the energy is applied at the surface of the components to be connected, transmission connecting methods apply the energy in between two plastic components at their interfaces. This can be done by irradiating the complete connecting portion, connecting structure or weld line at the same time, i.e., simultaneous light or laser transmission welding. Further methods include quasi simultaneous through transmission welding or contour welding, among others. Within the present invention, the usage of a simultaneous method is particularly preferred.

The through transmission connecting device 1 provided by the present invention is, however, adapted to a different technical application field, in particular the technical field of graphite electrodes for use in electrochemical cells of, e.g., a redox flow battery. As will be explained below, the through transmission connecting device 1 is not limited to the manufacturing of graphite electrodes or the processing of graphite but may be used in combination with any component having a light absorbing property, as well as a high thermal conductivity.

In this respect, and as graphite has a thermal conductivity of λ=119 to 165 W/(m K), in particular all materials having a thermal conductivity in the range of λ≥50 W/(m K), preferably λ≥75 W/(m K) and particularly preferred λ≥100 W/(m K), are considered as highly heat conductive materials.

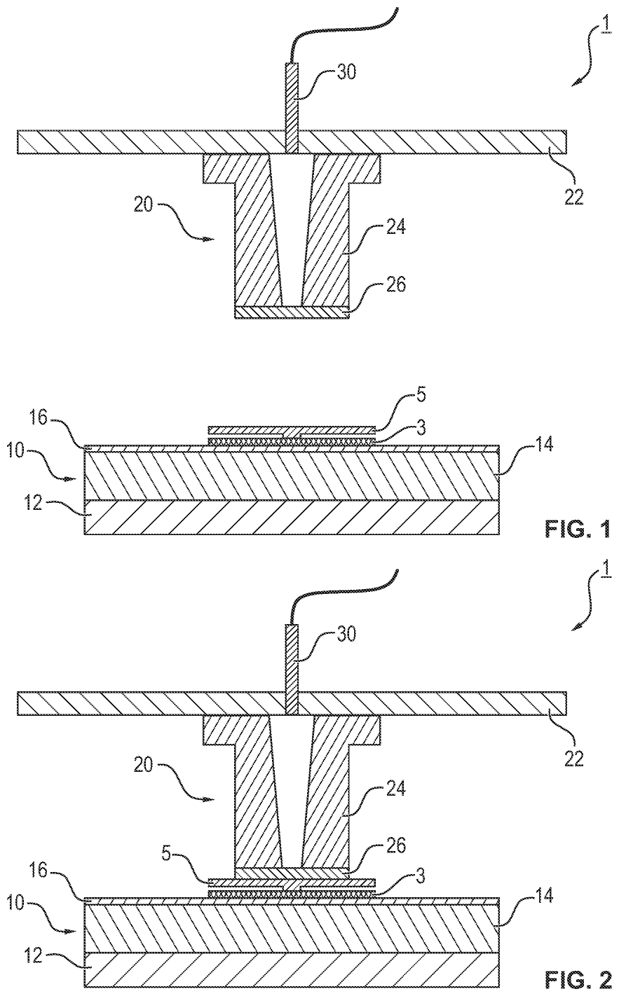

Now referring to FIG. 1, the general construction of the through transmission connecting device 1 is discussed. The through transmission connecting device 1 comprises a first tool 10 mounted to a first support 12 for receiving the first component 3, i.e., retaining the first component 3 in use. Further, the through transmission connecting device 1 comprises a second tool 20 mounted to a second support 22 for receiving the second component 5, i.e., retaining the second component 5 in use.

As shown, the first tool 10 is a lower tool. Accordingly, the first support 12 may be a lifting table or the like. The second tool 20 is, thus, an upper tool so that the second support 22 may present an upper mounting plate. The lifting table as first support 12 and/or the mounting plate as second support 22 are made of a metal, preferably steel or aluminum.

In the second support 22, an opening for fastening a light guide or laser fiber 30 is provided. The light guide or laser fiber 30 is connected with the opposing end to a laser light source (not shown). The second tool 20 is present as a negative waveguide 24, i.e., a waveguide 24 defining a cavity in its interior in which during later use laser light 32 exiting the laser fiber 30 is reflected. The waveguide 24 comprises at the exit end of the laser light 32, a transparent plate 26 to apply a force to the components 3, 5 to be connected by means of the second tool 20.

As discussed above, the first support 22 is a lifting table. By means of this feature, the first tool 10 and the second tool 20 are movable with respect to each other. In this regard, it must be noted that other arrangements are possible which provide a relative movement between the first tool 10 and the second tool 20.

Further, the first tool 10 comprises a layer of a thermal isolator 14 having a high thermal resistance. For qualifying as thermal isolator, it is preferred that the thermal isolator 14 has a thermal conductivity of λ≤2 W/(m K), preferably λ≤1 W/(m K).

Due to the process used, i.e., light transmission bonding technology, the thermal isolator 14 must, besides having this low thermal conductivity, fulfill further requirements which are inherent to this technology. For example, the first or absorbing component 3 is heated during the process by means of laser light. The thermal isolator 14 must thus have a respective thermal resistance, as mentioned above. In other words, a melting point of the thermal isolator 14 must be well above the temperature to which the absorbing component 3 is heated during the connecting method. To this end, the thermal isolator 14 has a preferably a melting point of tₘₚ≥200° C., preferably of tₘₚ≥250° C.

Further, the weld force applied during use for connecting the two components 3, 5 to each other must be considered. Accordingly, the thermal isolator 14 which must withstand this weld force and the resulting contact pressure must have a respective resistance in this regard, as well.

An exemplary material, which fulfills the above requirements, is a thermoplastic material, in particular a polyether ether ketone (PEEK). PEEK as a particularly preferred material for the thermal isolator 14 has on the one hand a very low thermal conductivity of about λ=0.25 W/(m K) and, on the other hand, possesses a high melting point of about tₘₚ=335° C. Additionally, PEEK has a sufficient resistance against the usually applied weld force F, as discussed above.

For the sake of completeness, the thermal isolator 14 has a thickness in the range of 1 mm≤tᵢ≤10 cm, preferably 2.5 mm≤tᵢ≤7.5 cm and particularly preferred 5 mm≤tᵢ≤5 cm. By means of these thickness ranges, heat conduction can at least be hindered or even prevented in a reliable manner. In this regard, the thickness of the thermal isolator 14 depends on and is interrelated with the material used. For example, a material having a low thermal conductivity, like PEEK, may be present in a smaller thickness compared to a material having a higher thermal conductivity for which a larger thickness may be required to hinder or prevent heat conduction into the first support 12.

On top of the layer of the thermal isolator 14, a non-stick coating 16 is present. Thus, the non-stick coating 16 is present at least in the contact area of the first tool 10 with the first component 3. The non-stick coating 16 consists preferably of polytetrafluoroethylene. Due to this coating, a sticking of the first component 3 to the first tool 10 can be prevented in a process reliable manner, as discussed below.

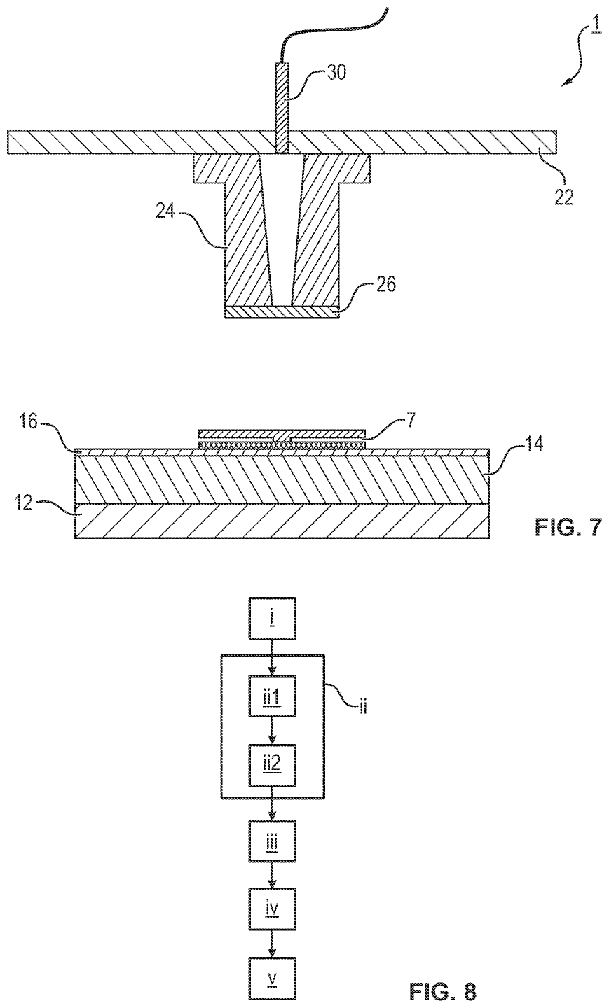

The structure and functioning of the adapted trough transmission connecting device 1 is now explained based on the exemplary production of a graphite electrode as a resulting connection structure 7, FIG. 7, for use in an electrochemical cell or the like.

The exemplary graphite electrode consists initially of the first or absorbing component 3, which is made of a light or laser absorbing material. In the present example, the first component 3 is a plastic matrix material filled with graphite particles. The second component 5, which provides for example a frame for a later mounting of the graphite containing first component 3 into a redox flow battery cell stack, consists of a plastic which is transparent for the light or laser light used. Nevertheless, and as discussed above, any other material having a high thermal conductivity can be used as the absorbing component 3, for example, a plastic matrix material filled with another mineral.

For connecting, i.e., bonding or welding, the first component 3 to the second component 5, the first component 3 and second component 5 are first arranged between the first tool 10 and the second tool 20. This state is shown in FIG. 1. Here, the first component 3 is arranged on the first tool 10 and the second component 5 is arranged on the first component 3. Nevertheless, any arrangement may be chosen in which the light, in particular the laser light, for heating the first component 3 at the connecting structure or portion comes from the second tool 20 and, thus first passes through the second component 5.

After the components 3, 5 have been arranged in the through transmission connecting device 1, the first tool 10 and the second tool 20 are moved relative to each other into a contact position, as shown in FIG. 2. Here, the first tool 10 and the second component 20 abut each other at least partly, preferably with the respective connecting portions.

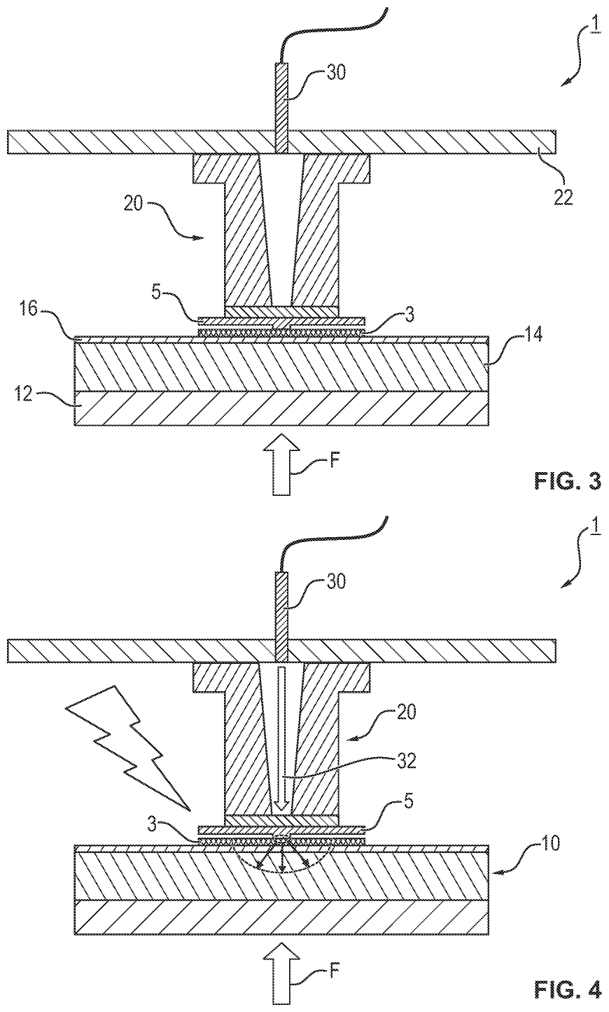

Thereafter, and as indicated in FIG. 3 by means of the weld force F, a contact pressure is applied on the first component 3 and the second component 5. The weld force F applied depends usually on the components to be connected. Specifically, the weld force F must be chosen such that a reliable connection is formed between the components while at the same time avoiding a damaging of the components. Accordingly, the thermal isolator 14 of the first tool 10 is resistant to the application of force, in particular to compression force, in the range required for suitably connecting the components to each other.

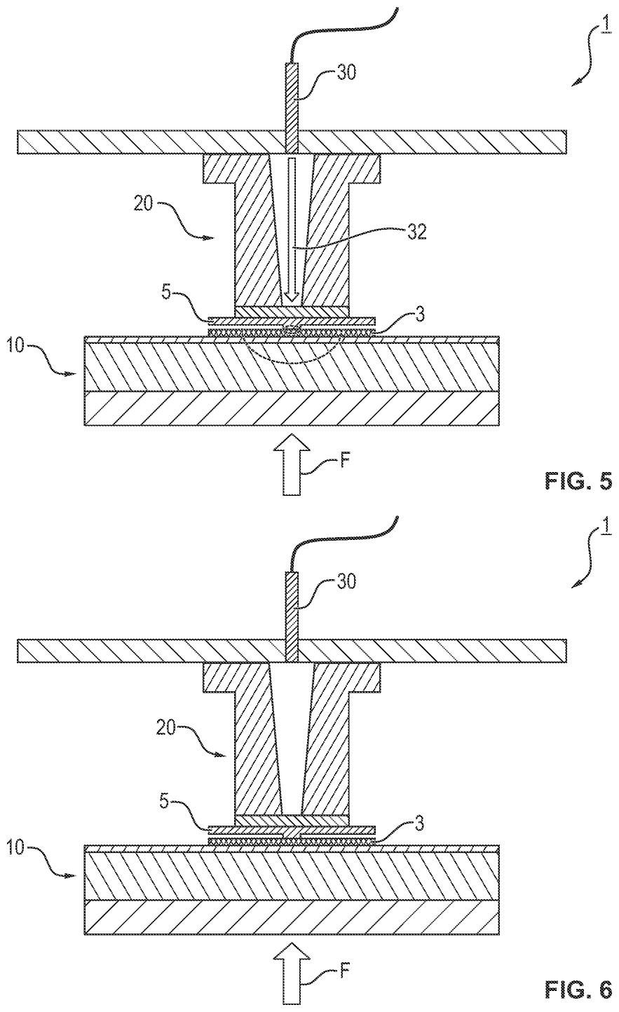

While maintaining the applied weld force F, the laser light source is switched on and the first component 3 as well as the second component 5 are irradiated by means of the laser light 32 exiting the laser light source (not shown), running through the laser fiber 30 into the waveguide 24 and through the plate 26. This is shown in FIGS. 4 and 5. Preferably, the first component 3 and the second component 5 are irradiated in the connecting portions or connecting structure.

The incident laser light 32 is absorbed by the lower first component 3 and transformed into heat within the material. Once the laser light 32 is converted into heat by the absorbing component 3, the thermal energy is transferred to the transparent component 5 to allow for it to soften and melt so that a melting zone results. By ensuring the two components 3, 5 are in intimate contact, the heat energy can be conducted to the transparent component 5.

For establishing a reliable connection by means of a light transmission bonding technology, the through transmission connecting device 1 is provided with the thermal isolator 14. Due to the usage of this thermal isolator 14, applying a through transmission connecting method for producing the exemplary graphite electrode as discussed above is realizable. This is because the thermal isolator 14 at least hinders or preferably prevents thermal conduction to, for example, the first support 12. As a result, the loss of thermal energy is avoided, and the connecting process is facilitated.

As shown in FIG. 6, the two components 3, 5 are pressed against each other even after the laser light has been switched off for allowing the softened material to harden. In particular, a recrystallisation of the softened or melted material is achieved.

Finally, and as shown in FIG. 7, the first tool 10 and the second tool 20 are moved relative to each other out of the connecting position. Now, a user can remove the produced connection structure 7, i.e., the exemplary graphite electrode having a frame element for assembly of the redox flow battery.

Based on the above explanations, it is a first difference to the prior art and a specific technical advantage that a light transmission bonding technology is used for producing a graphite electrode. Particularly the usage of this technology makes the production of the graphite electrode easier and more cost efficient.

In this regard, and particularly with respect to the through transmission connecting device 1, it was found that the through transmission connecting device 1 can further be used for any application, preferably any electrochemical application, in which a light or laser absorbing and highly heat conductive material as the first component 3 shall be connected, i.e., bonded or welded, to a light or laser transparent second component 5.

Now referring to FIG. 8, a flow chart of an embodiment of an inventive connecting method using the through transmission connecting device 1 for connecting a first component 3 made of a light absorbing material to a second component 5 made of a light transmissive material is discussed. As mentioned above, the first component 3 has a high thermal conductivity at least in a connecting portion. A high thermal conductivity is considered to be in the range of λ≥50 W/(m K), preferably λ≥75 W/(m K) and particularly preferred λ≥100 W/(m K).

In a first method step i, an arranging of the first component 3 in the first tool 10 takes place. In a second step ii, which may be performed before, after or at the same time as the first step i, an arranging of the second component 5 in the second tool 20 takes place. For further automatizing the method, it is preferred that the second step ii comprises the steps of arranging the second component 5 on the first component 3 in the first tool 10 (step ii1) and moving the first tool 10 and the second tool 20 relative to each other into a transfer position in which the second tool 20 receives the second component 5 (step ii2). By proceeding this way, the second component 5 is transferred automatically into the second tool 20, which eliminates the respective manual step.

After both components 3, 5 have been arranged appropriately, a moving of the first tool 10 and the second tool 20 relative to each other into a connecting position in which the first component 3 and the second component 5 abut each other at least partly, preferably with the respective connecting portions, is performed in step iii.

In the connecting position, a weld force is applied in step iv on the first component 3 and the second component 5. Further, the first component 3 and the second component 5 are irradiated by means of the light source while applying or maintaining the weld force. The respective light source is preferably a laser light source.

Subsequently, a moving of the first tool 10 and the second tool 20 relative to each other out of the connecting position is performed in step v. After this step has been performed, the user may remove or unload the resulting connection structure 7 from the through transmission connecting device 1.

### List of Reference signs—FIGS. 1-8

1 through transmission connecting device
3 first component
5 second component
7 connection structure
10 first tool
12 first support
14 thermal isolator
16 non-stick coating
20 second tool
22 second support
24 waveguide
26 plate
30 light guide or laser fiber
32 laser light
F weld force

It will be apparent that other modifications and variations of the foregoing exemplary embodiments will be understood from the foregoing description, as well as the following claims.

1. A through transmission connecting device for connecting a first component made of a light absorbing material to a second component made of a light transmissive material by means of a light transmission bonding technology, the through transmission connecting device comprising:
a a first tool mounted to a first support retaining the first component; and
b a second tool mounted to a second support retaining the second component, wherein
c the first tool and the second tool are movable with respect to each other and
d the first tool is at least partly made of or comprises a layer of a thermal isolator having a high thermal resistance.

2. The through transmission connecting device according to claim 1, wherein the thermal isolator has a thermal conductivity of λ≤2 W/(m K).

3. The through transmission connecting device according to claim 1, wherein the thermal isolator has a thermal conductivity of λ≤1 W/(m K).

4. The through transmission connecting device according to claim 1, wherein the thermal isolator has a melting point of tₘₚ≥200° C.

5. The through transmission connecting device according to claim 1, wherein the thermal isolator has a melting point of tₘₚ≥250° C.

6. The through transmission connecting device according to claim 1, wherein the thermal isolator is a thermoplastic material.

7. The through transmission connecting device according to claim 1, wherein the thermal isolator is a polyether ether ketone (PEEK).

8. The through transmission connecting device according to claim 1, wherein the thermal isolator has a thickness in the range of 1 mm≤tᵢ≤10 cm.

9. The through transmission connecting device according to claim 1, wherein the thermal isolator has a thickness in the range of 2.5 mm≤tᵢ≤7.5 cm.

10. The through transmission connecting device according to claim 1, wherein the thermal isolator has a thickness in the range of 5 mm≤tᵢ≤5 cm.

11. The through transmission connecting device according to claim 1, wherein the first tool further comprises a non-stick coating adjacent to the thermal isolator such that the non-stick coating is present at least in a contact area of the first tool with the first component.

12. The through transmission connecting device according to claim 11, wherein the non-stick coating consists of polytetrafluoroethylene.

13. The through transmission connecting device according to claim 1, wherein at least one of the first support and the second support are at least partly made of a metal.

14. The through transmission connecting device according to claim 1, wherein at least one of the first support and the second support are at least partly made of steel or aluminum.

15. A connecting method using a through transmission connecting device according to claim 1 for connecting a first component made of a light absorbing material to a second component made of a light transmissive material, wherein the first component has a high thermal conductivity at least in a connecting portion and the connecting method comprises the steps of:
a arranging the first component in the first tool,
b arranging the second component in the second tool,
c moving the first tool and the second tool relative to each other into a connecting position in which the first component and the second component abut each other at least partly, thereafter,
d applying a weld force on the first component and the second component as well as irradiating the first component and the second component by means of a light source while applying the weld force and subsequently,
e moving the first tool and the second tool relative to each other out of the connecting position.

16. The connecting method according to claim 15, wherein the light source is a laser light source.

17. The connecting method according to claim 15, wherein the step of arranging the second component in the second tool comprises the steps of:
b1 arranging the second component on the first component in the first tool and
b2 moving the first tool and the second tool relative to each other into a transfer position in which the second tool receives the second component.

18. The connecting method according to claim 15, wherein the thermal conductivity of the first component is in the range of λ≥50 W/(m K).

19. The connecting method according to claim 15, wherein the thermal conductivity of the first component is in the range of λ≥75 W/(m K).

20. A connection structure having a first component made of a light absorbing material and a second component made of a light transmissive material, wherein the first component has at least in a connecting portion, in which it is connected to the second component, a high thermal conductivity.
